(19) United States
(12) Patent Application Publication
(10) Pub. No.: US 2003/0137634 A1
(43) Pub. Date: Jul. 24, 2003

(54) Method and kit for making ophthalmic lenses

(76) Inventors: Christopher Mark Dungar, Uetendorf (CH); Roy Dungar, Devon (GB)

Correspondence Address: Hovey William, Suite 400, 2405 Grand, Kansas City, MO, 64108, US

(21) Appl. No.: 10/182,235

(22) PCT Filed: Jan. 22, 2002
(86) PCT No.: PCT/IB01/00060

(51) Int. Cl. G02C 7/02

(52) U.S. Cl. 351/159

(57) ABSTRACT

In the present method, the lens maker forms a first side (2) of a semi-finished lens blank (1) to give it a desired shape. A flexible transparent wafer (4) with an optical coating (7) is then attached to the first side (2) of the blank (1). The wafer (4) serves as a substrate for the coating (7) and allows to attach the coating quickly to the newly shaped side of the blank, thereby avoiding the delays that would be required in order to apply an optical quality coating to the blank directly.

### CROSS REFERENCES TO RELATED APPLICATIONS

This application claims the priority of Swiss patent application 0128/00, filed Jan. 24, 2000, the disclosure of which is incorporated herein by reference in its entirety.

### TECHNICAL FIELD

The invention relates to a method and a kit for making eyewear lenses according to the preamble of the independent claims.

### BACKGROUND ART

A major problem for the quick production of lenses is the time required to apply coatings, such as protective hardcoatings and antireflective coatings. To overcome this problem, lens blanks with pre-fabricated and fully coated front sides are used, such that the lens maker only has to grind the back side. In order to save time, the back side is left uncoated, which leads to a lens of lesser quality than a lens coated on both sides.

Therefore, it has been proposed to provide kits of pre-fabricated lens halves for the back and front side of the lens, which then are glued together according to the customer's needs. In order to satisfy all needs, such kits have to be very extensive. In addition to this, the halves have standard diameters, which generally leads to unnecessarily thick final products.

U.S. Pat. No. 5,851,328 describes a method for assembling lenses from a piece and a back piece. In this method, the front piece is thinner than the back piece. Before joining the two pieces, the front piece is heated for purpose of softening. Then, the front piece is pushed against the back piece thereby plastically deforming it to match the back piece's contour. This method is, however, unsuited for being used with pre-coated lens pieces s because the heating and plastic deformation would generaly damage coatings.

### DISCLOSURE OF THE INVENTION

The problem to be solved by the present invention is to provide a system that allows a quick production of a custom manufactured lens with one or more optical quality coatings.

This problem is solved by the independent claims.

Hence, according to the invention, the lens maker shapes a first side of a semi-finished lens blank to give it a desired form, e.g. according to a given lens prescription. Then, a flexible wafer with an optical coating is attached to the first side of the blank. The wafer serves as a substrate for the coating and allows to attach the coating quickly to the newly shaped side of the blank, thereby avoiding the delays that would be required to apply an optical quality coating to the blank directly.

Preferably, the wafer is elastically deformed while it is being attached to the blank so that it follows its shape accurately. Since the wafer is flexible, this step can be carried out at room temperature.

When an adhesive is used between the wafer and the blank, there is no need to polish the first side of the blank to optical quality. Roughness can be hidden by the adhesive, which when correctly chosen creates a transparent, optical quality interface between the wafer and the blank.

The coating applied to the waver can e.g. be a hardcoating, an anti-reflective coating or any combination of optical coatings and/or tintings. A hardcoating is a coating harder than the wafer and the blank to provide protection against scratching and abrasion.

In a preferred embodiment, a kit of wafers having differing curvatures is provided and the lens maker chooses a wafer having a curvature such that it will deform to the desired shape.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a blank (a semi finished lens) for making a finished lens,

FIG. 2 shows the blank of FIG. 1 after shaping the back surface,

FIG. 3 shows a wafer to be adhered to the blank, and

FIG. 4 shows the assembled lens of blank and wafer.

### MODES FOR CARRYING-OUT THE INVENTION

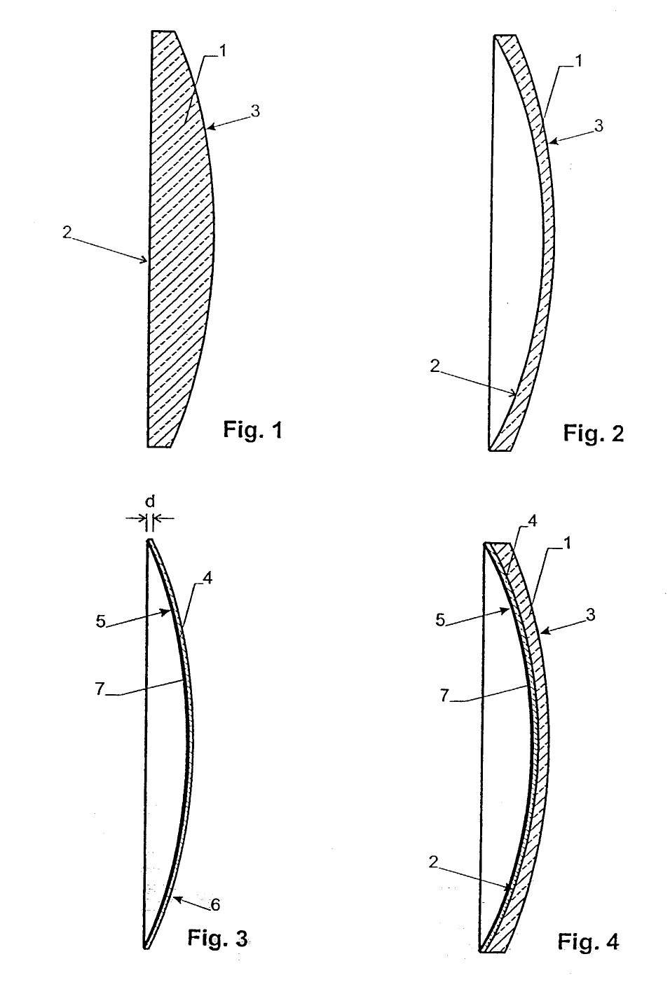

A preferred process for making a lens is depicted in FIGS. 1-4.

The maker of the lens, who is e.g. an ophthalmic technician grinding lenses adapted to the needs of his customers, starts by choosing a semi-finished lens blank 1 as shown in FIG. 1. It may e.g. be made from a transparent plastic or glass.

Lens blank 1 has a first side 2 and a second side 3. First side 2 is unfinished and may e.g. be flat. Second side 3 is finished to have a known curvature and optical quality, and it may already be provided with s suitable coatings, such as an anti-reflective coating and a hardcoating. Such coatings are known to a person skilled in the art.

A lens maker usually stores a selection of blanks 1 with differing second side curvatures. When making a lens, the lens maker chooses a blank having a suited second side curvature. The first side 2 of the blank is then shaped to a desired form adapted to the individual needs of the user. Methods for shaping a blank of this type, e.g. by machining, in particular grinding, are known to a person skilled in the art.

As will be explained below, no polishing is required after shaping, i.e. the shaped surface can e.g. be opaque and does not need to have optical quality. Nor does it have to be coated.

After shaping, first side 2 has a desired form and curvature as shown in FIG. 2. Since it corresponds to the back side of the lens, it is usually shaped into a concave form. It may be spherical but in general it will be “cylindrical”. A “cylindrical surface” in this context is a toric surface having differing curvatures in the orthogonal axes directions, as it is e.g. used for correcting astigmatism.

In a next step, the lens maker chooses a wafer 4 as shown in FIG. 3. The wafer used here is a flexible object having a first wafer surface 5 and a second wafer surface 6. It is preferably made of a transparent plastic, such as CR39. A typical thickness of the wafer is between 0.05-0.5 mm so that it can be easily deformed some few millimeters while it has sufficient rigidity to maintain its shape if it is handled with care.

The first wafer surface 5 is already provided with an optical coating 7, such as a hardcoating and an anti-reflective coating.

For choosing a suited wafer, the lens maker uses a kit comprising of a plurality of flexible, coated wafers. These wafers are generally spherical in their relaxed state and have different curvatures. The method is not restricted to spherical wafers, though, because cylindrical or toric generic sets of wafers can also be used for cases of extreme differences in curvature in the principal axes. As the wafer will be attached to first blank side 2, the lens maker chooses a wafer having a curvature close to the one of first blank side 2. Preferably, the curvature of the wafer corresponds substantially to the average of the curvatures in the principal axes of first blank side 2. In the case of a cylindrical or torical wafer, the smaller radius of the wafer would differ from the smaller radius of the first blank side 2 by a similar extent as the difference between the larger radius of the wafer and the larger radius of the blank. For simplifying this step, the kit comes with a pre-calculated table listing suited wafers for given minimum and maximum curvatures of first blank side 2.

After having selected a suitable wafer 4, a transparent adhesive is attached to first blank side 2 and wafer 4 is pressed against it. Since, in general, wafer 4 and first blank side 2 will have differing toric (or spherical) shapes, wafer 4 is elastically deformed while being pressed against first blank side 2 and assumes the shape of first blank side 2. Alternatively, the adhesive may be attached to the wafer instead of first blank side 2 before the two component parts are pressed together.

If first side 2 is such that the curvatures in the principle axes are different, the curvature of wafer 4 is increase. In one direction whilst it is decreased in the other because the original curvature of wafer 4 was chosen to lie between the minimum and the maximum curvature of first blank side 2. This minimizes the strain that wafer 4 and its coating 7 are subjected to.

The adhesive between wafer 4 and blank 1, which is preferably index-matched to both the wafer and the blank, creates a fully transparent interface between the components, even if first blank side 2 and/or the second wafer side 6 is unpolished.

The adhesive hardens to form a lens as shown in FIG. 4. The lens can then be cut to a desired shape and inserted into an eyewear frame.

Wafer 4 can be applied to blank 1 at room temperature because wafer 4 is sufficiently elastic to adapt its shape to the one of first side 2 of blank 1. In order to remove strain quickly, tempering of the finished lens may, however, be advantageous.

The back side of the finished lens of FIG. 4 is formed by first wafer surface 5, which carries the coating 7. In other words, by applying wafer 4 to blank 1 after shaping, a coating is applied to the lens. Since adhering wafer 4 to blank 1 can be done quickly, the process is rapid. Therefore, the method described here allows to apply a high quality coating to a lens in a quick and efficient manner.

The wafer 4 has preferably uniform thickness d (see FIG. 3), i.e. it does not substantially affect the optical power of the lens. In other words, both wafer surfaces 5 and 6 are substantially parallel to each other.

In the examples discussed so far, wafer 4 carried a hardcoating, and an antireflective coating. The wafer can, however, carry other types of coatings, such as photochromic, polarizing or absorbent coatings or layers or tints or any single coating or combination of coatings.

A photochromic, polarizing or absorbent coating or layer may also be located between blank 1 and wafer 4.

While there are shown and described presently preferred embodiments of the invention, it is to be distinctly understood that the invention is not limited thereto but may be otherwise variously embodied and practiced within the scope of the following claims.

1. A method for making an ophthalmic lens comprising the steps of
choosing a pre-made, semi-finished lens blank (1) having an unfinished first side (2) and a finished second side (3) and
then shaping the first side (2) of the lens blank (1) to a desired form,
characterised by the step of
choosing a flexible wafer (4) having an optical coating on at least one wafer (4) surface and
attaching the wafer (4) to the first side (2) of the lens blank (1).

2. The method of claim 1 wherein the wafer (4) is only elastically deformed while being attached to the first side (2) of the lens blank (1) to follow the desired shape.

3. The method of claim 2 wherein the desired shape has a first curvature in a first direction and a second curvature in a second direction, wherein said first and second curvature are different, and wherein the wafer (4) has, in a relaxed state, a substantially spherical shape with a given third curvature, wherein the third curvature lies between said first and second curvature.

4. The method of one of the preceding claims wherein the wafer (4) is attached to the first side (2) of the lens blank (1) substantially at room temperature.

5. The method of one of the preceding claims wherein the wafer (4) is attached with an adhesive to the first side (2) of the lens blank (1).

6. The method of claim 5 wherein the first side (2) is not polished to optical quality and wherein the adhesive creates a transparent, optical quality interface between the wafer (4) and the blank (1).

7. The method of one of the preceding claims wherein the wafer (4) is made of a plastic.

8. The method of one of the preceding claims wherein the wafer (4) is coated by an anti-reflective coating and/or hardcoating and/or a tinted coating and/or a polarizing coating.

9. The method of one of the preceding claims wherein the wafer (4) has a thickness of less than 0.5 mm, in particular between 0.05 and 0.5 mm.

10. The method of one of the preceding claims comprising the step of choosing the wafer (4) from a kit of wafers, said kit comprising wafers of differing curvatures.

11. The method of one of the preceding claims wherein the wafer (4) consists of a transparent, coated and/or tinted plastic.

12. The method of one of the preceding claims wherein a second side (3) of the blank (1) opposite to the first side (2) has been shaped to a coated, optical quality curved surface prior to shaping the first side (2).

13. The method of one of the preceding claims wherein the first side (2) of the lens blank (1) is shaped to a concave form.

14. The method of one of the preceding claims wherein the wafer (4) is, in a relaxed state, curved.

15. The method of one of the preceding claims comprising the step of tempering the lens.

16. The method of one of the preceding claims wherein the wafer is transparent.

17. The method of one of the preceding claims wherein the first side (2) of the lens blank after shaping and the wafer (4) prior to attaching have different toric shapes.

18. A kit of-making ophthalmic lenses by shaping a first side (2) of a lens blank (1) to a desired form comprising a plurality of flexible transparent wafers (4) of differing curvatures having an optical coating on at least one wafer surface.

19. The kit of claim 18 wherein the wafers have substantially spherical shapes.

20. The kit of one of the claims 18 or 19 wherein the wafers have a constant thickness, in particular of less than 0.5 mm, preferably between 0.05 mm and 0.5 mm.
